(19) United States
(12) Patent Application Publication
(10) Pub. No.: US 2021/0234667 A1
(43) Pub. Date: Jul. 29, 2021

(54) METHOD AND SYSTEM FOR PROOF OF ELECTION ON A BLOCKCHAIN

(71) Applicant: NEURALIA TECHNOLOGIES INC., Brossard (CA)

(72) Inventor: Jean-Denis Boudreault, Longueuil, QC (CA)

(21) Appl. No.: 17/265,442

(22) PCT Filed: Aug. 1, 2019
(86) PCT No.: PCT/CA2019/051052

§ 371 Date: Feb. 2, 2021

Related U.S. Application Data
(60) Provisional application No. 62/713,742, filed on Aug. 2, 2018.

(51) Int. Cl. H04L 9/06

(52) U.S. Cl. CPC H04L 9/0618; H04L 2209/463; H04L 2209/38; H04L 9/0643

(57) ABSTRACT

Methods, systems and computer readable media for proof of election on a blockchain are provided. According to an aspect, the methods, systems and computer readable media include: a) publishing a block on a blockchain network, said block including at least one criterion for selecting an elected actor based on a unique election candidacy; b) receiving election confirmations messages from one or more actors, said election confirmation messages including the unique election candidacy and one or more transactions selected by said one or more actors; c) applying the at least one criterion to validate elected actors based on the unique election candidacy; and d) publishing a subsequent block on the blockchain network, said subsequent block including the one or more transactions in the election confirmation messages received from the elected actors.

### TECHNICAL FIELD

The technical field generally relates to blockchain technology, and more particularly to methods and systems for proof of election on a blockchain.

### BACKGROUND

A blockchain is a series of operations or transactions that are cemented into a sequential append only database format. An important technology making blockchains possible is the hashing algorithm. A cryptographic hash is an algorithm that will take any input value, and for each unique input value, always produce a unique output. The same input will always create the same output, but no two different input will ever create the same output. This way, a hash is a way to create a unique identifier for specific content, where the original content that produced the hash may never be deduced from the resulting hash alone.

Each transaction is confirmed into a blockchain database by being included into a block. Each block will contain multiple transactions that have been confirmed as cryptographically valid. When a new block is created, its contents will be hashed combining the hash of the previous block in the chain. This goes on and on as the blockchain grows forming a chain of blocks. This technology is interesting, as there is no way an attacker can change anything in the blockchain. Any tampering with the data as an attempt to corrupt it, even the smallest digit will completely change the hashing chain sum and corrupt the links. This is important, as it allows to ensure that data received from untrusted computers on the internet is valid, by summing up the chain of hashes.

A blockchain database, with its cryptographic chain of hashes, ensures that it is impossible to tamper with its data. This way, computers connected to each other in a somewhat random manner can create a self healing peer to peer network. Each computer connects to other nodes on the network, and they themselves connect to others, forming a communication mesh. If one peer should become unresponsive, the network is never affected as it will naturally rebalance itself using other connections. The peers on this network will exchange and synchronize the blockchain data without ever trusting each other. The cryptographic hash allows each peer to sum up the data and confirm that it was sent and received as intended.

Built on top of the network topography established by the peer to peer network is a gossip messaging protocol. This protocol determines the way messages are exchanged between each peer on the p2p network as to ensure that every node will receive a copy of messages sent on the network, while minimizing message repeats (echos). When new transactions are created to insert into the blockchain, a node will send this transaction as a gossip message to the multiple peers it is connected to, and they will in turn forward it to their own peers and this continues until the entire network has received the message. The new transaction will be validated and then added to the temporary transaction pool by each actor, where it will stay indefinitely until it is confirmed by a confirmation block. Once confirmed, it is removed from the transaction pool and appended to eternity into the final blockchain.

One of the main difficulties to overcome on a peer to peer blockchain network is how to establish consensus on what is considered to be the truth on the network. On a big network with millions or more of nodes, it becomes difficult to establish who is right when a lot of activity happens at a same time and potential ill intended actors are present. For example, if someone spends money from the same account twice, at the same time from opposing ends of a network. As the message will travel on the network, some nodes will see one transaction, but be unaware of the second. At the same time, others will see the second, but be unaware of the first. The two sets of nodes both see a different version of the truth for the same point in time. When these transactions start to collide, then another group of nodes will see both. Out of these 3 groups, the question is then, who is right? What if the combination of the two transactions result in an overdrawn account? How do we process the exception?

To answer these question, blockchain systems implement various consensus mechanism to help establish the truth on the network at a certain time. The consensus is a mechanism by which an authority is decided and mutually agreed upon to select the transactions that will be established as truth for a time slice in the blockchain. Ideally, a different node would be selected every time in an unpredictable manner to be the designated authority.

Although it is not the only consensus mechanism, the most popular by far at the time of this writing is a consensus method called proof of work (POW). How this works is that a network will ask nodes on the network to find the solution to a very difficult mathematical problem all at the same time. All nodes will search for a mathematical “needle in a haystack” so to speak, to ensure that only one winner will emerge after a specified period. When a lucky node finally finds an answer to this mathematical problem, it gets to lead for one turn and select which transactions will make it into a block and publish the block to the network. Once the other actors on the network validate and accept the solution, it is accepted as truth, and the network moves on to the next block. Essentially, the proof of work algorithm serves the purposes of choosing somebody on the network to get to chose where the blockchain will go for this turn. Because these calculations are so difficult, it ensures a certain entropy in who will be chosen next, and thus nobody can plan to get to decide where the chain will go next ensuring protection from calculated corruption.

The POW algorithm works very well for its philosophical purpose and is the basis for a vast majority of blockchain technologies. The problem with POW is that it prevents fraud by using the cost of computer hardware and electricity as its fraud limiting factors. One with an infinitely powerful computer could find the block solution every time instantly and reduce network entropy to zero. However, computers have power limits and electricity is expensive, thus limiting the ability people have to operate on the network infinitely.

The problem with this is, as blockchain technology becomes more popular, people will use increasingly more powerful computers and increasing energy demand to find more block solutions. This leads to a constant increase in network difficulty level, and thus an ever-increasing use of energy, which keeps increasing every day. In a day and age where the threat of global warming is upon us, this constant arms race is very alarming.

There is therefore much room for improvement.

### SUMMARY

According to an aspect, a method is provided. The method includes the steps of: a) publishing a block on a blockchain network including a plurality of actors, said block including at least one criterion for selecting an elected actor among the plurality of actors based on a unique election candidacy associated with each one of said actors; b) receiving election confirmations messages from one or more actors, said election confirmation messages including the unique election candidacy associated with each of said one or more actors, and one or more transactions selected by said one or more actors; c) applying the at least one criterion to validate elected actors among the one or more actors based on the unique election candidacy included in the election confirmation messages; and d) publishing a subsequent block on the blockchain network, said subsequent block including the one or more transactions in the election confirmation messages received from the elected actors.

According to an aspect, a system is provided. The system includes: a communications module configured to communicate with a plurality of actors on a blockchain network; and a processing module operatively connected to the communications module. The processing module is configured to: publish a block on the blockchain network via the communications module, said block including at least one criterion for selecting an elected actor among the plurality of actors on the blockchain network based on a unique election candidacy associated with each one of said actors; receive election confirmations messages from one or more actors via the communications module, said election confirmation messages including the unique election candidacy associated with each of said one or more actors, and one or more transactions selected by said one or more actors; apply the at least one criterion to validate elected actors among the one or more actors based on the unique election candidacy included in the election confirmation messages; and publish a subsequent block on the blockchain network via the communications module, said subsequent block including the one or more transactions in the election confirmation messages received from the elected actors.

According to an aspect, a non-transitory computer readable medium is provided. The computer readable medium has instructions stored thereon which, when executed by a processor, cause the processor to perform the steps of: a) publishing a block on a blockchain network including a plurality of actors, said block including at least one criterion for selecting an elected actor among the plurality of actors based on a unique election candidacy associated with each one of said actors; b) receiving election confirmations messages from one or more actors, said election confirmation messages including the unique election candidacy associated with each of said one or more actors, and one or more transactions selected by said one or more actors; c) applying the at least one criterion to validate elected actors among the one or more actors based on the unique election candidacy included in the election confirmation messages; and d) publishing a subsequent block on the blockchain network, said subsequent block including the one or more transactions in the election confirmation messages received from the elected actors.

### BRIEF DESCRIPTION OF THE DRAWINGS

FIGS. 1A and 1B are schematics illustrating actors participating in a blockchain network, according to an embodiment.

FIGS. 2A and 2B are schematics illustrating contents of blocks emitted on the blockchain, according to first and second embodiments.

FIG. 3 is a schematic illustrating election results included in an emitted block, according to an embodiment.

FIGS. 4A and 4B are flow charts illustrating exemplary processes for proof of election on a blockchain, according to first and second embodiments.

FIG. 5 is a schematic illustrating a proof of election process implementing a manifestation grace period, according to an embodiment.

FIGS. 6A and 6B are flow charts illustrating a process for determining whether an actor is elected, according to first and second embodiments.

FIG. 7 is a schematic illustrating a filter for selecting a prime elected actor, according to an embodiment.

FIG. 8 is a flow chart illustrating a process for registering a public actor on a blockchain network, according to an embodiment.

### DETAILED DESCRIPTION

What follows describes exemplary embodiments of systems and methods for proof of election on a blockchain and provides examples for possible implementations including system components and processes. These are but one of many different possible implementations. As such, the examples provided should not be taken as to limit the scope of the invention in any way.

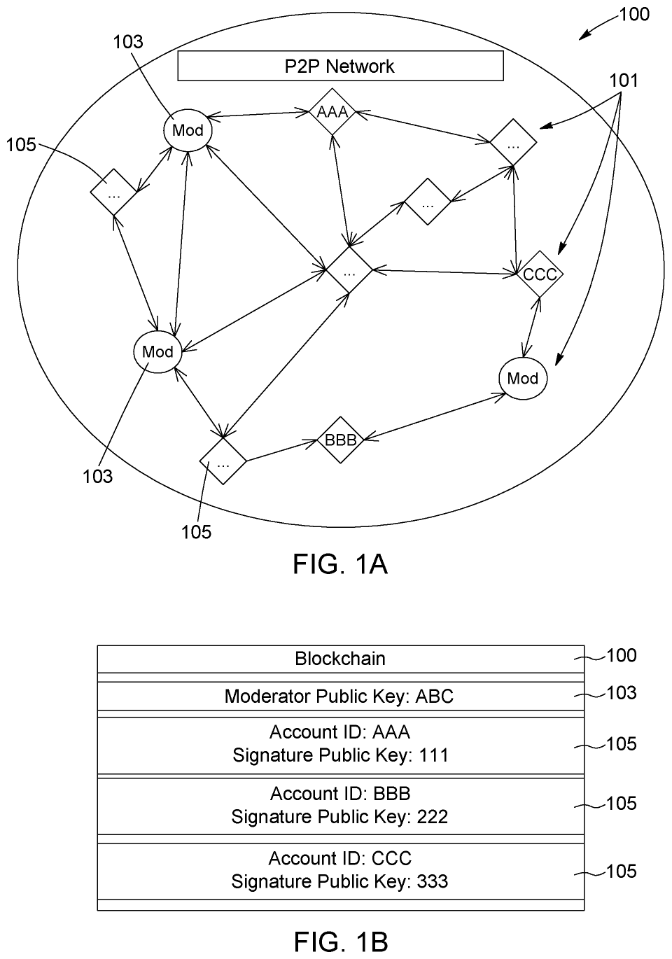

With reference to FIG. 1A, a blockchain network 100 for implementing a blockchain including a proof of election process is shown according to an embodiment. The network 100 comprises a plurality of nodes or actors 101 connected in a peer-to-peer fashion and communicating using a gossip protocol. The actors 101 can be any type of computing device comprising a processor, memory, and a communication module allowing the computing device to communicate with other computing devices in a peer-to-peer network and participate in performing actions pertaining to a blockchain. In some embodiments, the communication module can further allow the computing device to communicate with other computing devices (such as a server) via communication protocols outside of a peer-to-peer or blockchain network.

As can be appreciated, each actor 101 can be configured to perform different functions or roles in the blockchain network 100. In the present embodiment, the actors are subdivided into two subgroups, namely trusted actors 103, 107, and public actors 105. The main functions of trusted and public actors will be described in more detail hereinbelow. However, as can be appreciated, trusted actors can correspond to nodes operated by a trusted entity, and whose actions in the blockchain network can be subject to little or no supervision. Such nodes can, for example, be charged with verifying the actions of other nodes and/or making authoritative decisions on the blockchain network, for example taking the role of a moderator 103 (ex: for moderating actions taking place on the blockchain) and/or an IP validating actor 107 (ex: for validating the IP addresses of nodes registering on the network), among others. Public actors 105, on the other hand, can correspond to any entity participating in the blockchain network, and whose actions will need to be validated and/or authorized by trusted actions 103, 107, and/or by consensus of multiple public actors 105. At any given time, there can be different numbers of trusted actors and/or public actors on the network 100. However, in the embodiments described herein, a minimum of 4 actors are required, including at least one moderator 103, at least one IP validating actor 107, and at least two public actors 105.

Broadly described, moderators 103 are trusted nodes and/or specially designated nodes with reserved functions for authorizing actions taking place on the blockchain. The moderator 103 can correspond to a single computing device, and/or can include a plurality of computing devices (such as one or more servers, including a webserver and a backend server for example) which work together to perform moderating functions. In embodiments with more than one moderator 103, the moderators 103 coordinate with one another and act as a single unified voice on the blockchain network 100. In the present embodiment, as shown in FIG. 1B, moderators 103 are identified on the blockchain 100 through cryptographically secure public signature keys that can be published in special blocks, for example such as in the genesis blocks. Only moderators 103 with access to corresponding private key signatures will be able to impersonate the trusted voice on the blockchain network 100. Since the moderator voice is secured by cryptography, public actors 105 can recognize and trust that the messages and blocks that the moderators 103 emit are sent from a trusted source.

IP validating nodes 107 are trusted nodes and/or specially designated nodes with reserved functions for validating the identity of actors 105 participating on the blockchain network 100. In the present embodiment, these nodes are referred to as “IP validating” nodes in that they validate the unique identity of actors 105 by confirming their IP addresses, for example when the actors 105 are elected. It is appreciated, however, that the unique identify of actors 105 can be verified via other parameters as well. In the present embodiment, IP validating nodes 107 are specialized nodes with the sole function of validating the IP addresses of actors 105 and confirm such validation with the moderators 103 and/or the rest of the blockchain network 100. It is appreciated, however, that in some embodiments, the functions of IP validating nodes 107 can be carried out by moderators 103.

Public actors 105 correspond to other actors on the blockchain network 100. In the present embodiment, all public actors 105 have an assigned globally unique identifier, also referred to as an account number. As can be appreciated, no two actors can own the same account number, and the identifiers can be assured to be unique and uniquely managed at creation time by publishing the unique account number to the blockchain, in combination with one or more cryptographic signature public keys which only the actor controls. In some embodiments, this unique identity can also be the public encryption key, as long as it is unique on the blockchain and they alone control the private key.

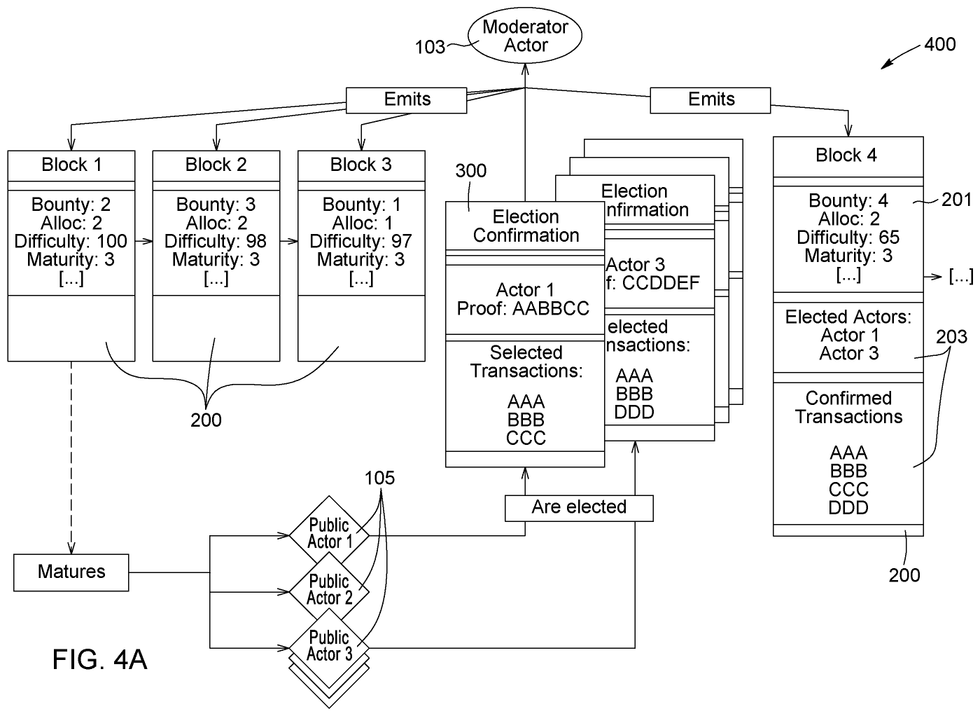

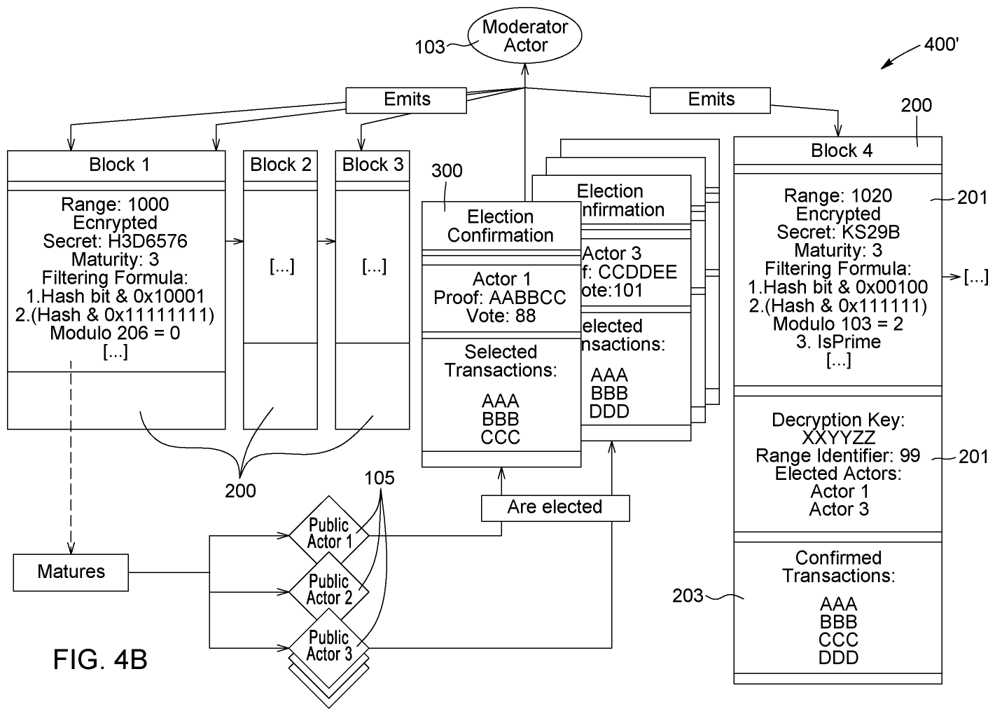

A first exemplary embodiment of a proof of election process 400 using trusted nodes is illustrated in FIG. 4A. Broadly described, a chain of blocks 200 is emitted by moderators at varying intervals depending on network load. When a particular block 200 reaches maturity, two or more public actors 105 are elected to select what transactions should be included in the matured block 200. The elected public actors 105 submit election confirmation messages 300 to the moderator 103, confirming their identities, and submitting their selected transactions. The moderator 103 can subsequently validate the identities of the elected actors 105, and a subsequent block 200 emitted by the moderators 103 can confirm the transactions submitted by the elected actors 105. In the present embodiment, all communications between moderators 103 and actors 105 are carried out over the blockchain network. It is appreciated, however, that in some embodiments, some communications can occur using different mechanisms. For example, election confirmation messages can be sent directly and/or indirectly from actors 105 to moderator 103 instead of being published on the blockchain network. Such messages can be sent, for example, via a direct P2P connection between actors 105 and moderator, and/or using a client-server relationship and/or via different protocols such as using the Hypertext Transfer Protocol (HTTP) or other communication protocols.

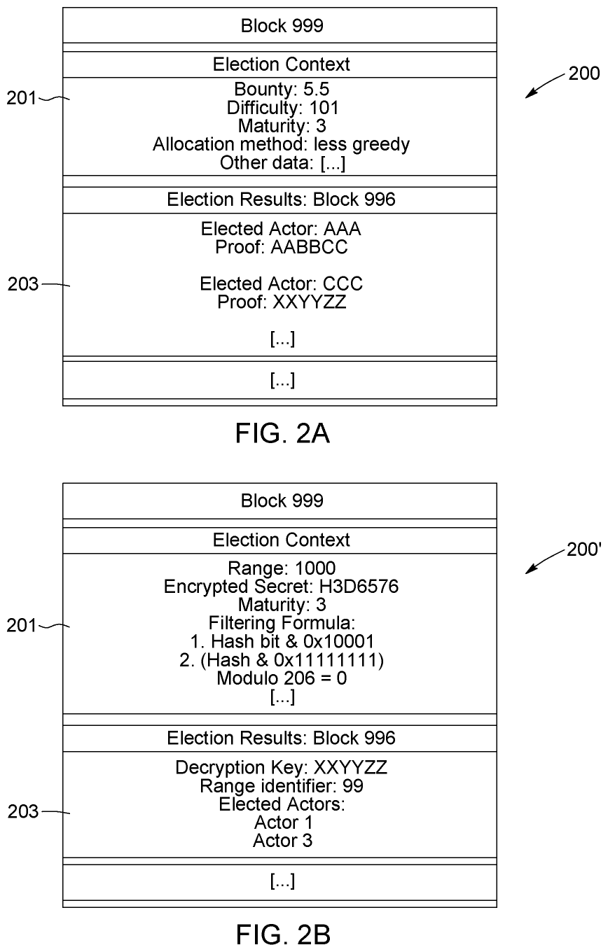

In more detail now, and as illustrated in FIG. 2A, each time a block 200 is created, it can include at least two different sections, namely election context 201 and election results 203. It is appreciated, however, that in other embodiments, more sections can be provided in each block 200, depending on particular functional requirements. The election context section 201 can determine the required parameters and commonly agreed upon rules that public actors will use for an election that will be held when maturity time is reached for the given block. In the present embodiment, the parameters provided in context section 201 include: a bounty amount to define a reward amount that will be split among the elected actors; a difficulty factor which determines the strength of the selection filter; a maturity height that determines when an election is due to take place; and an allocation method which determines the method by which the bounty will be allocated among the elected nodes. In the illustrated embodiment, the allocation method is set as “less greedy”, although it is appreciated that a different allocation method can be selected from a predetermined list of allocation methods, for example to achieve different goals in the blockchain by influencing the choices the nodes will perform and encouraging specific behaviors as may be required to keep the blockchain ecosystem healthy. Although particular factors are provided in the present embodiment, it is appreciated that other factors may also be added to increase selection complexity like random nonce values for example.

The election results section 203 can be used to publish the final election results of the block that reaches maturity at the current block height. The election results section 203 can therefore contain a list indicating the nodes elected in this block, as well as the portion of the bounty that is allocated to each one of them. The allocation of the bounty can be determined by any way that is necessary. For example, it can be split equally among all elected nodes, or special algorithms can be used to establish a smarter allocation of values. For example, the selected transaction fees for each elected actor can be summed up, and higher bounties can be assigned to the elected actors that chose transactions that offered lower fees, as an incentive to clear the lower paying transactions from the blockchain pool.

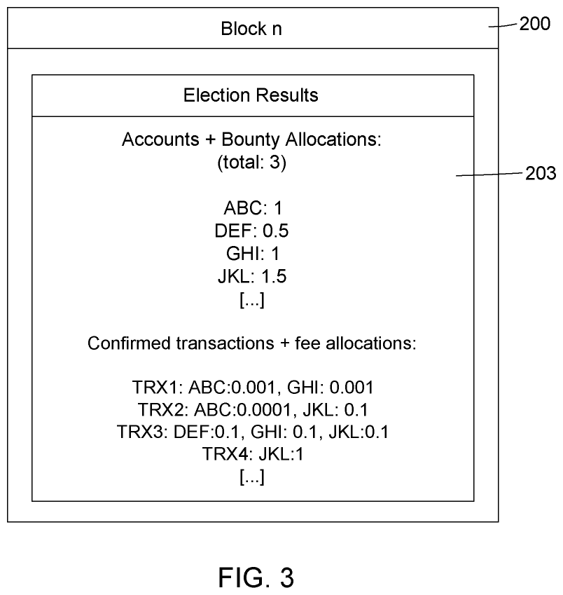

As mentioned above, when public actors 105 are elected, they have an opportunity to select which transactions they wish to add as truth to the current block. Such transactions can be selected from a pool of incomplete transactions (i.e. proposed transactions which have been broadcasted to the network by other public actors 105, but which have not yet been processed and added to the blockchain). Accordingly, the election results section 203 can also be used to indicate any transactions the elected representatives wish to include in the block. As illustrated in FIG. 3, confirmed transactions that were selected by the various elected nodes can be listed in the election results section 203, along with the portion of the transaction fees that are offered to each elected node. As can be appreciated, the allocation of the transaction fees can be carried out in many different ways. For example, it can be split fairly, it can be assigned randomly among all elected nodes, or special formulas can be used, for example using special formulas using factors such as which transaction was received first, which one has been elected the least often in a specified period of time, etc.

As can be appreciated, the number of public actors 105 elected can vary from one block to another. Each time a block 200 is created, the moderators 103 specify the election context parameters in the election context section 201, and these parameters are used to determine the rules by which a given number of public actors 105 will eventually be elected. Therefore, the number of elected actors 105 can be greater or fewer depending on how the parameters are set.

Several different factors can be provided in order to set the election rules. In the present embodiment, the election factors include at least a difficulty controlling factor to control the number of elected actors 105. The difficulty factor can correspond to any filtering condition which narrows down the number of actors that can be elected. For example, the difficulty factor and comprise a probability that any given actor can be elected. In some embodiments, this can be achieved by setting a rule which states that the actors 105 to be elected are those who have an account and hash combination lower than a provided difficulty number. Alternatively, a similar rule can be set by electing actors 105 having an account and hash combination closest to the difficulty number.

As can be appreciated, a large number of public actors 105 can participate in the network 100 at any given time, and it would not be desirable to elect all of those nodes to select transactions at the same time. Accordingly, the difficulty factor can serve to limit the number of elected actors to a manageable amount and avoid too much load on the network 100. In some embodiments, the difficulty factor can be set such that a relatively constant number of actors 105 are elected for each block. For example, the difficulty factor can be set such that there is an average of 10 elected actors 105 each block. However, it is appreciated that the optimal number of elected actors 105 can vary according to the total amount of actors 101 participating in the network and/or the size of the unconfirmed transaction pool, among other factors. Accordingly, the difficulty factor can be adjusted from block to block to adjust the expected number of elected actors 105 as required.

In some embodiments, statistical methodologies can be employed to determine the ideal difficulty factor, for example based on feedback from elections in previous blocks. As can be appreciated, this can allow for a relatively constant proportion of elected representatives 105 for the total amount of actors 101 on the blockchain. In such embodiments, the moderators 103 can monitor the number of elected actors 105 in previous blocks, and adjust the difficulty factor up or down to keep the count of elected actors near a fixed predetermined amount.

A certain amount of entropy can be added to the system in order to make it more difficult to predict which actors will be elected in a future turn. In the present embodiment, such entropy is added by way of defining a maturity time for each block 200. As described above, blocks 200 emitted by the moderators 103 can specify the maturity time in the election context section 201. The maturity time can serve to force a delay between when blocks 200 are emitted, and when a corresponding election should be carried out (i.e. when the block “matures”). For example, the maturity time can be defined as a block number increase, meaning that a given block will only mature once a predetermined number of subsequent blocks have been emitted. In such embodiments, the maturity time can be provided as a dynamic variable, or can be a fixed mutually agreed constant defined in the blockchain code. It is appreciated that other mechanisms for delaying election are possible. It is also appreciated that further entropy can be added via other mechanisms, for example by adding random nonce values or other data.

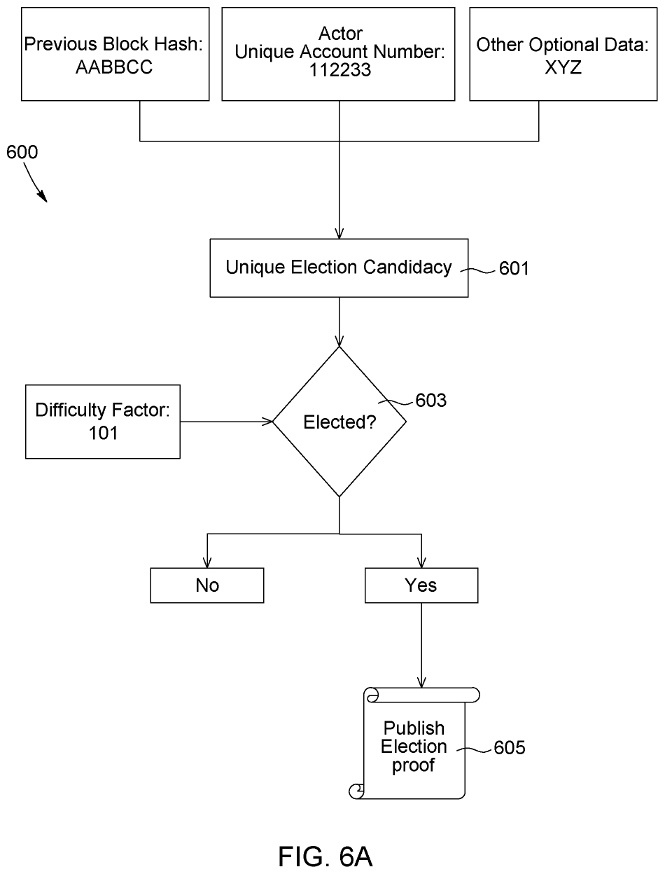

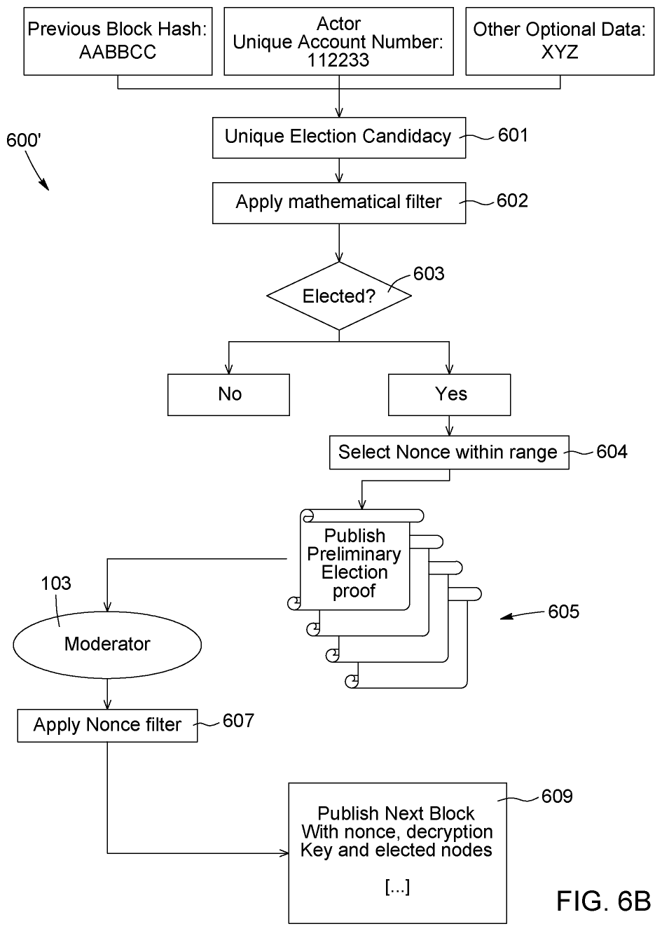

Once a given block 200 has reached maturity according to its specified election context, the actors 105 will have to perform a sequence of actions in order to determine whether they have been elected. An exemplary method 600 for determining whether an actor 105 has been elected is illustrated in FIG. 6A. In the present embodiment, the method 600 comprises a first step 601 of establishing a unique election candidacy. The unique candidacy is established by the actor 105 by hashing together the unique hash of the previous block on the blockchain with its own unique ID, thereby creating a new unique hash. As can be appreciated, the mechanism for generating a unique candidacy can be based on predetermined rules, agreed across the blockchain, and can thus be calculated differently and/or can incorporate different factors. Moreover, additional information, such as nonces declared in the election context, may be used as well.

Once the unique election candidacy has been calculated, a second step 603 can involve determining whether the unique candidacy falls within a range determined by the filtering formula. For example, the actor 105 can take into account the difficulty factor and determine whether the hash defining the unique candidacy is below a threshold defined by the difficulty factor.

If the actor 105 determines that it does not fall within the required range, then it has not been elected, and no further action needs to be taken. The actor 105 can thus wait for the next block to get another opportunity at being elected. If the actor 105 does fall within the filtering range, then the actor 105 has been elected and will have the opportunity to participate in deciding what transactions will be included in the current block. More particularly, this involves a step 605 of publishing an election confirmation to the network 100. The election confirmation 103 can indicate the transactions that the actor 105 has chosen to be included in the block, along with the hash defining the actor's unique candidacy to prove that it has in fact been elected. The election confirmation can be signed with the actor's 105 private key to avoid being impersonated.

The moderator nodes 103 receive and gather election confirmation messages, and validate the account number, signatures and election proofs. If properly validated, the moderators 103 can include the transactions selected in the election confirmation messages in the next emitted block 200. In some embodiments, the moderators 103 can merge transactions from all elected actors 105 into the next block, while in other embodiments, the moderators 103 can choose to give a particular actor 105 a privileged or prime elected actor status, thus letting the privileged actor decide the contents of the next block by itself. As can be appreciated, in the next block, the moderator 103 can adjust the difficulty based on the amount of elected actors 105 from the previous block, to assure a relatively constant proportion of representative actors 105 being elected. The same process can then be repeated for all subsequent blocks.

In the present embodiment, the election confirmation message is published on the blockchain network 100 by the elected actor 105. The moderator 103 will thus receive the election confirmation message by monitoring communications on the blockchain network 100. It is appreciated, however, that other mechanisms for communicating election confirmation messages are also possible. For example, in some embodiments, when an actor 105 determines that it has been elected, it can communicate directly or indirectly with one or more moderators 103 via a channel separate from the blockchain network 100 and/or using different communication protocols. For example, the actor 105 can communicate with a webserver (or other computing device) controlled by one or more moderators 103 in order to send its election confirmation message via HTTP or other communication protocol. Upon receipt of the message, the moderator 103 can confirm the identity of the actor 105 (for example based on the IP of the actor 105 obtained via the HTTP connection, or via another communication protocol) and use the contents of the election confirmation message in the next emitted block 200. In some embodiments, the moderator 103 can publish the received election confirmation message to the blockchain network 100 on behalf of the elected actor 105. In this fashion, the moderator 103 can serve as a central connection point to facilitate communication via actors 105 and the blockchain network 100.

A second exemplary embodiment of a proof of election process 400′ is shown in FIG. 4B. In this embodiment, the general steps of the process 400′ are similar to the first embodiment 400 describe above in that blocks 200 are emitted by a moderator 103 and upon maturity, one or more public actors 105 are elected to determine which transactions to include in the matured block 200. The elected actors 105 submit election confirmation messages 300 to the moderator 103 directly and/or indirectly via the blockchain network 100 and/or via another channel, confirming their identities, and submitting their selected transactions. The moderator 103 can subsequently validate the identities of the elected actors 105, and a subsequent block 200 emitted by the moderators 103 can confirm the transactions submitted by the elected actors 105. A particularity of the present embodiment is that mathematical filters are used to limit the number of actors 105 which can be elected for any given block. Accordingly, additional information is provided as part of the election context and election confirmations.

More specifically, as illustrated in FIG. 2B, the election context 201 of a block 200 can include a difficulty range and an encrypted nonce number. As can be appreciated, the nonce number can be randomly selected from a difficulty range by the entity emitting the block (in this case the moderator 103), and the difficulty range can be predetermined based on the level of entropy required for the network to operate properly. The election context 201 can thus indicate the range in which the nonce number was generated, and the nonce number, encrypted using a symmetrical encryption key so that it can be revealed in the future.

The election context 201 can further include one or more filtering mathematical formulas or programmatic scripts. These scripts can help determine a filter which the actors will need to adhere to in order to be candidates for election. As can be appreciated, the filtering formulas can be any mathematical formulas of varying complexity which can allow to narrow down the number of actors which are to be elected. By way of example, the formula can comprise a hash filter mechanism whereby the moderator publishes a number of bits out of 128 which the actors will need to have set as ‘1’ in their hash. For example, the moderator can specify that actors having a hash with 1 s at bit positions 3 and 122 are eligible for election, and that everyone else will be eliminated. This can be continued for subsequent rounds to further narrow down the elected pool based on how many actors should be elected. The number of bits specified in each round can also be adjusted to narrow down the number of elected actors. As can be appreciated, this is but one of many different possible algorithms. In some embodiments, a plurality of such algorithms can be predetermined and programmed into the blockchain code, for example as function 1, function 2, function 3, etc., and the moderator can select one or more of these functions by indicating the function in the election context 201. In some embodiments, new functions can be created by the moderator 103, and the rules for those functions can be specified as part of the election context 201.

As can be appreciated, given the use of mathematical filters, the actors 105 may need to perform additional steps to confirm whether it has been elected. An exemplary method 600′ for determining whether an actor 105 has been elected using mathematical filters is shown in FIG. 6B. In the illustrated embodiment, the method 600′ comprises a first step 601 of establishing a unique election candidacy. The unique candidacy can be established by the actor 105 by hashing together the unique hash of the previous block on the blockchain with its own unique ID, thereby creating a new unique hash. As can be appreciated, the mechanism for generating a unique candidacy can be based on predetermined rules, agreed across the blockchain, and can thus be calculated differently and/or can incorporate different factors.

Once the unique election candidacy has been calculated, a second step 603 can involve determining whether the actor 105 is eligible for election. This can involve a sub-step 602 of performing the series of programmatic filters on its unique candidacy in order to determine election eligibility.

If the actor 105 determines that it has been excluded by the filter scripts, then it has not been elected, and no further action needs to be taken. The actor 105 can thus wait for the next block to get another opportunity at being elected. If the actor 105 determines that it falls within the filtering range, it can be considered as being an election candidate and can participate further in the election process. In step 604, the actor 105 can subsequently select a random number within a range defined in the election context, and in step 605 submit the random number as part of an election confirmation message 300 along with the transactions that the actor 105 has chosen to be included in the block, and the hash defining the actor's unique candidacy to prove that it has in fact been elected. The election confirmation can be signed with the actor's private key to avoid being impersonated.

The moderators 103 receive and gather election confirmation messages from all the candidates that came forward. Then, in step 607, the moderators 103 determine which actors 105 among the election candidates are selected as elected actors 105. This can be done, for example, by applying a nonce filter, using the secret nonce number. As can be appreciated, the nonce filter can use any applicable formula, and this formula can be published in the election context and/or predetermined in the blockchain code. For example, the nonce filter can be configured to select the actors 105 who submitted a random number closest to the predetermined nonce number, or furthest from the nonce number. Once the elected actors 105 have been determined, in step 609, the moderators 103 can emit the next block, indicating therein the elected candidates as well as the decryption key of the secret nonce, so that all other nodes on the network 100 can reveal the hidden nonce and confirm that the elected candidates are valid.

In some embodiments, election confirmations can be subject to a time limit or grace period in order to encourage actors 105 to remain active on the blockchain and listen for new elections to verify. For example, the grace period can correspond to a predefined number of blocks following the election block number, although it is appreciated that the grace period can be defined using other parameters, such as an elapsed time. Once the grace period expires, the moderators 103 can publish a block incorporating transactions from election confirmations received during the grace period. Any election confirmations pertaining to an election for which the grace period has expired can simply be ignored by the moderators 103. In this fashion, if the elected actors 105 do not act fast enough following their election, they will miss out on their opportunity to select transactions, and will lose out on their potential bounty.

In some instances, it is possible that no actor 105 will be elected during a block, for example if the filtering is too aggressive. In such cases, the moderators 103 can wait a predetermined period of time before declaring the election round forfeited. In some embodiments, when an election is forfeited, the difficulty level can be adjusted to reflect this and a subsequent block can be emitted with a new adjusted election context which will trigger a new election. In some embodiments, when an election is forfeited, the moderator 103 can be charged with deciding which transactions to include in the current block, in order to ensure that transactions continue to be confirmed on the blockchain and ensure a healthy ecosystem.

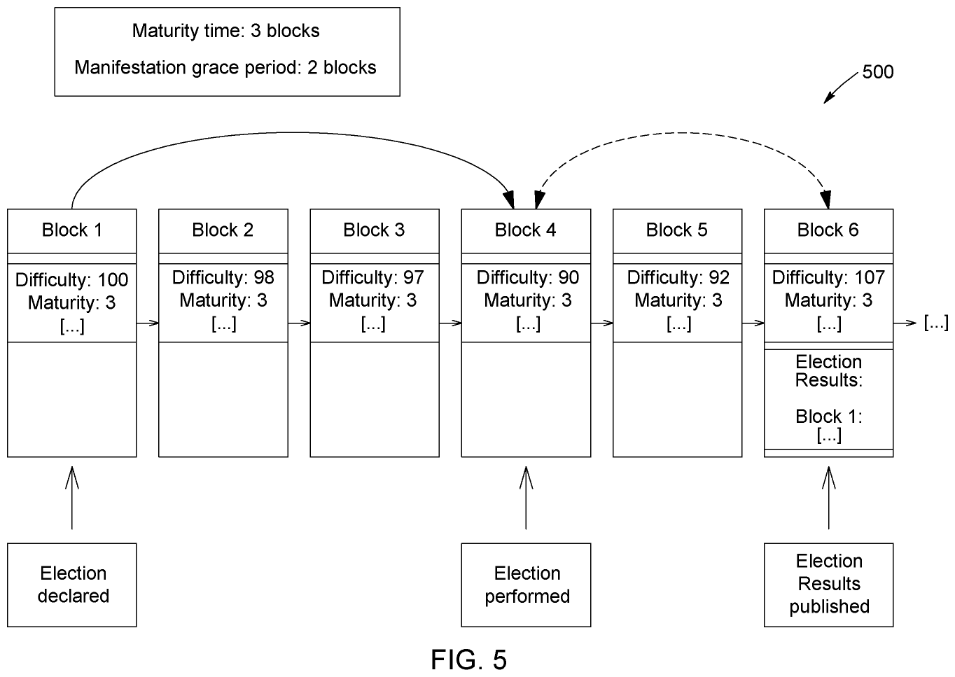

By way of example, FIG. 5 illustrates an exemplary process 500 having a maturity time of three blocks and a manifestation grace period of two blocks. A first block, Block 1, is emitted by the moderators, including a specified difficulty level and the maturity time. The emission of this block effectively declares that an election will occur once the maturity time of three blocks has been reached. Blocks 2 and 3 are subsequently emitted, and since no actors have been elected, the difficulty is reduced to compensate. When Block 4 is emitted, Block 1 has reached maturity, and an election is performed. Elected actors therefore submit their election confirmation messages which are received and confirmed by the moderators. During this time, Block 5 is emitted with an increased difficulty to account for a number of actors having been elected. When Block 6 is emitted, the manifestation grace period has expired. Therefore, the election results and corresponding transactions selected by the elected actors are included in Block 6, thereby cementing the transactions in the blockchain. Any election confirmations pertaining to the election initiated at Block 4 are subsequently ignored, due to the expiration of the manifestation grace period.

In the embodiments described herein, the election process is substantially decentralized in that each actor 105 is tasked with verifying whether or not it has been elected. It should be appreciated, however, the in some embodiments, the election process can be more centralized, for example to reduce noise on the network 100 by eliminating election confirmation messages sent by each elected actor 105. In such embodiments, the moderators 103 can be responsible for themselves determining which actors 105 are to be elected, and notifying the actors 105 that they have been elected when emitting blocks 200. As can be appreciated, the moderators 103 has access to all the account numbers on the chain, and can determine which actors 105 have been elected by checking the election conditions itself against every actor 105 account currently existing in the chain. The moderator 103 can subsequently include a list of elected actors 105 in the next block 200 to notify the actors 105 that they have been elected. Alternatively, the moderator 103 can notify elected actors 105 by communicating with them directly and/or indirectly outside the blockchain network 100, for example using a different communication protocol. The actors 105 can accept the election as valid, as they can themselves confirm that they satisfy the election conditions. Once an actor 105 has confirmed that it has been elected, it can continue to select the transactions to include in the next block 200 by transmitting a transaction message on the network 100, and/or transmitting a message directly and/or indirectly to the moderator 103 via another channel outside the network 100. The moderator 103 will receive the transaction message, validate its origin, and add the transactions into a future block 200 to confirm the transactions. As can be appreciated, this approach can greatly reduce the network load by reducing the list of elected actors 105 to a minimum before asking them to come forward with their transactions choices via a network message. Such an approach can be useful for saving resources, especially if the amount of actors on the network should become very high.

A particularity of the embodiments of the present proof of election method is that a plurality of actors 105 can be elected in any given block election, especially if the election context includes a low difficulty and/or if there is a large number of actors 105 on the network 100. As can be appreciated, each of the plurality of elected actors can have their own voice, each can select separate and/or potentially overlapping transactions to include in a given block. Therefore, the method can include a mechanism for handling multiplicity of elected actors 105. For example, in some embodiments, the method can include a step of merging respective choices of the multiplicity of actors 105, such that all the chosen transactions can be included in the next block, with each elected actor 105 being treated as a co-decider. It is appreciated, however, that multiplicity of actors 105 can be handled in different ways, such as giving exclusivity to a particular elected actor 105 in a current block, while allowing other elected actors 105 to have exclusivity in upcoming blocks.

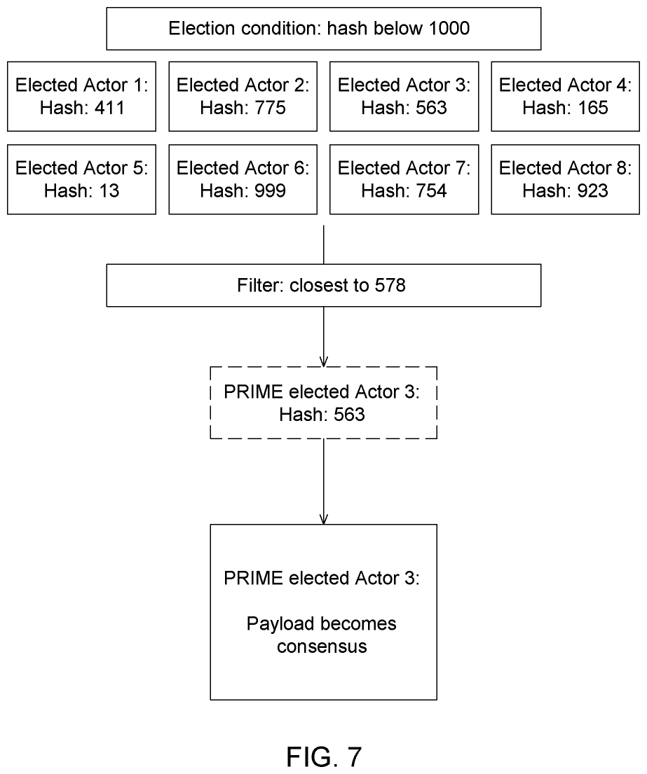

In some embodiments, the multiplicity of elected actors 105 can be handled by selecting a prime elected actor among all the elected actors. This selection can, for example, be carried out by the moderators 103. As can be appreciated, after the election results are received, the moderators 103 can use the results to select a single prime elected actor among all the elected actors. The prime elected actor can be given the opportunity to have an exclusive decision on which transactions to include in the next block. As with the election process, any type of filter can be used. For example, the prime elected actor can be selected based on the actor with the highest hash, the actor who holds the most funds, the actor with the oldest registration date, etc. In some embodiment, for example as illustrated in FIG. 7, the filter can be based on which actor has a hash closest to a randomly generated number. Such criteria can be published in the initial election context, such that all actors can be aware of the rules, and such that the moderators 103 can be held accountable for their selection.

By way of example, in embodiments in which a prime elected actor is used, the moderators 103 can publish a block with an election context specifying both the parameters for election and the parameters for prime election. The moderators 103 can subsequently monitor the election confirmation messages from elected actors 105, and analyze/compare the messages to determine which one gets to be the sole elected actor and thus the sole decider of the contents of the next block. Since the prime elected actor criteria are published as part of a block, every actor 105 on the blockchain network 100 will know the rules. Moreover, the election confirmation messages are also available to all actors 105 on the network 100, so all actors 105 will be able to confirm exactly who was elected, and who was selected as the prime elected actor. In this fashion, every actor 105 can verify that the moderators 103 are playing by the defined rules, and that they are behaving as they should. This can give public actors 105 the ability to ensure that the moderators 103 are held accountable for their decision, and bad behaviour on their part can be proved using the blockchain's immutable ledger as proof.

In the embodiments described herein, a subset of actors 105 on the network 100 is elected to select which transactions will be part of the next block. To encourage actors 105 to participate in the blockchain and select transactions, the election process can reward elected actors 105 for their work, such as via bounties and/or transaction fees for completing transactions. These bounties and/or transaction fees can be in the form of the same crypto token being exchanged on the network 100 via the transactions. Providing such rewards can allow for “mining” to be carried out on the blockchain.

A bounty can comprise a reward which is paid by the network 100 to elected actors 105 for completing transactions (i.e. by creating new units of crypto tokens and allocating them to the elected actors 105). The bounty can, for example, be specified and published in every new block that is created, for example in the election context section. A transaction fee can be a reward which is paid by an actor initiating a transaction. The transaction fee can, for example, be specified and published when an actor 105 broadcasts a transaction request to the network 100. As can be appreciated, elected actors 105 can choose to prioritize transactions which offer higher transaction fees in order to make the highest return possible.

Once the moderators 103 receive transaction selections from elected actors 105, the moderators 103 can decide how the bounty and/or transaction fees are split among the elected actors 105. In some embodiments, bounties can be split evenly among all elected actors 105, whereas transactions fees can be divided up equally among all elected actors 105 which chose the corresponding transactions. In other embodiments, mathematical filtering can be applied to decide how bounties and/or transaction fees a distributed and in what proportions. For example, if multiple elected actors 105 selected a transaction AAA because it was offering the highest transactions fee, then the first actor 105 to have sent the selection (for example based on a timestamp) could be selected to be awarded the transaction fee. Alternatively, the actor 105 having sent a selection with a timestamp closest to a random number could be selected. As can be appreciated, different filtering algorithms can be applied. The parameters of the filtering algorithms can, for example, be specified in the election context and/or as a general rule in the programmatic code of the blockchain protocol.

Embodiments of the presently described method can be carried out with relatively little processing power. Contrary to other blockchain methods, the actors 105 are not required to carry out computationally intensive calculations to be granted the privilege of selecting transactions. Accordingly, in the present method, processing power and electricity are not a limiting factor for participating in the blockchain. Therefore, embodiments of blockchain networks employing the present method can be made up of low power devices, such as IOT devices. Regardless of their processing power, each device can be afforded a fair and equal opportunity to select transaction to be included in blocks.

While this aspect of the method can be particularly advantageous, it is appreciated that there is potential for a single entity (such as a single powerful computer) to present itself as a plurality of actors 105 on the network 100, and thus have a higher probability of being elected. In fact, depending on the number of overall actors 105 on the network, a single entity could be in a position to decide most or all transactions if it represents a significant high enough proportion of the network. Accordingly, to avoid such situations, some embodiments of the present method can comprise a mechanism for introducing one or more limitation factors, for example to prevent multiple identity fraud, i.e. a single entity or computer presenting itself as multiple actors 105 on the network.

For example, in some embodiments, the method can comprise a registration process for registering and validating new actors 105 wishing to participate on the network 100. The registration process can include, for example, registering the IP address of new actors 105 wishing to participate on the network, such that they can be uniquely identified, and preventing another entity with the same IP address from registering more than once. Messages on the network 100 from actors 105 which have not yet registered can simply be ignored, thus allowing only actors 105 having validly registered to participate on the network 100.

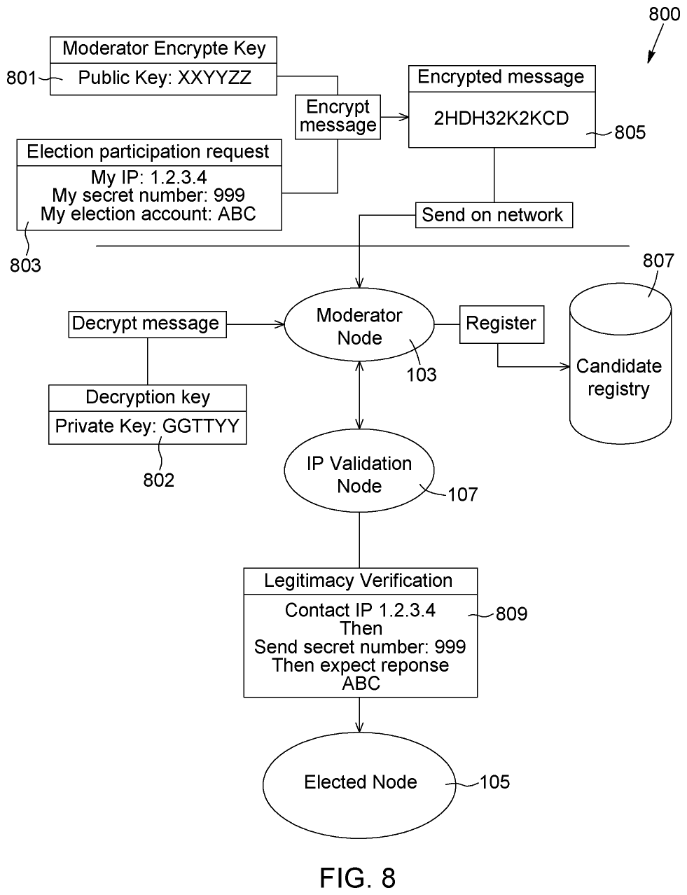

With reference to FIG. 8, an exemplary process 800 for registering on the network is shown according to an embodiment. In the illustrated embodiment, a moderator node 103 publishes a public asymmetrical encryption key 801 to all members of the network. Only the moderator 103 will have the corresponding private key 802 and be able to decrypt messages encrypted with the public key 801. When a public actor 105 wants to register and be eligible to participate in the election process, it prepares election participation request 803 which can contain its IP address, a random secret number (i.e. a password), and a unique account number. This information can then be encrypted using the moderator's public key 801 and published as an encrypted message 805 to the network 100.

As it monitors messages on the network 100, the moderator 103 will receive the encrypted message 805, and can decrypt it using its private key 802. The moderator can register the information contained therein into a candidate registry or database 807, thus registering the public actor 105 as active for elections at the IP address specified in message 805. Therefore, from that point forward, election confirmation messages received from the registered public actor 105 will be recognized and processed by the moderator.

Although in the present embodiment registration is carried out on the blockchain network 100, it is appreciated that other mechanisms are also possible. For example, in some embodiments, registration can be carried out via a webserver or other type of registration server or computing device. In such embodiments, the actor 105 can send a registration request via HTTP and/or another communication protocol to a webserver or other computing device controlled by moderator 103. The registration request can include a unique account name/number and password. Upon receiving the request, the moderator 103 can obtain the actor's IP address with the HTTP connection or via another communication protocol, and push the registration information to a backend server comprising the candidate registry or database 807. This information can subsequently used to identify and validate communications from the actor 105 on the blockchain network 100. It is further appreciated that this information can be used to communicate directly and/or indirectly with the actor 105 over other connections and protocols, and validate the actor's identity during such communications.

In some embodiments, the IP address of elected actors transmitting election confirmation messages can be confirmed prior to including selected transactions in a block and thus cementing the selected transactions in the blockchain. For example, the network 100 can comprise IP validation nodes 107, corresponding to trusted nodes whose function is to confirm the legitimacy of an elected actor 105. As can be appreciated, IP validation nodes 107 can be distinct nodes, or the functions of IP validation nodes 107 can be integrated into moderator nodes 103. The IP validation node 107 can be configured to contact the actor 105 at its corresponding registered IP address via a legitimacy verification message 809. This communication can be done outside the blockchain network 100 using a different communication protocol. The legitimacy verification message 809 can include the secret number registered by the actor 105. Upon receipt of verification message 809, the actor 105 can verify the secret number, and if it is correct, the actor 105 can respond with a message which includes the account number which it is currently using to run for elections. If the IP validation node 107 receives an account number that corresponds to the account number registered in the candidate registry 807 in association with the IP address, then the actor 105 can be confirmed as valid. Transaction selections from actors 105 confirmed as valid can be included in subsequent blocks, whereas transactions from actors 105 who have failed validation can be ignored.

As can be appreciated, the validation process described above can be carried out at different frequencies and/or intervals depending on functional requirements of the blockchain. For example, in some embodiments, the validation process can be carried out every time an election confirmation message has been received by a moderator 103. In other embodiments, the validation process can be carried out at regular and/or random intervals. In some embodiments, the validation process can be carried out when a new actor 105 registers as an election candidate on the network 100.

As can be further appreciated, validating actors 105 in this fashion can ensure that there is only one actor 105 or account per IP address. IP addresses are thus used as a limiting factor. Due to the difficulty to get such addresses, it can efficiently limit the ability of one entity to present itself as many actors 105 or election candidates. Although IP addresses have been described as a potential limiting factor, it is appreciated that other limiting factors can be used as well, and that actors 105 can be validated in a similar fashion. For example, the MAC address of a device can be used to identify actors 105, and/or a secret number emitted by a central authority, and/or a combination of the above factors.

In the embodiments described herein, the election process operates on a substantially centralized model in that trusted moderators 103 are required to validate election confirmations and establish what information is included in blocks. It is appreciated that in some embodiments, the election process can operate on a substantially decentralized model, operating for example without any moderator nodes 103.

For example, in some embodiments the first election in the genesis block can include a very easy difficulty factor. Among the multiple elected actors that will manifest themselves at the beginning of the blockchain, a filter can be applied to choose only one prime elected actor among the lot. For example, multiple elected actors can broadcast their election candidacy, such that every other actor can receive it in a viral fashion. The prime elected actor can subsequently be identified by all actors by applying the filter. For example, the actor with the smallest hash among all elected actors can be chosen as the designated prime elected actor. Each actor can apply the filter individually to determine who it believes to be the elected actor, and the elected actors can be designated based on a consensus reached by all the actors on the network, i.e. by 51% or more of actors on the network. The prime elected actor can then choose the contents of the next block and set the conditions for the subsequent election. When setting the conditions for the subsequent election, the prime elected actor can provide a new proposed difficulty factor based on previous elections to make sure that a selected percentage of the network is fairly represented in the elected candidates. Other actors on the network can validate the proposed difficulty factor to ensure that it falls within a predetermined range, based on their own evaluation of previous elections. If the other actors reject the proposed difficulty, then another prime elected actor can be chosen using filter, for example by choosing the elected actor having the second smallest hash. This can continue until a valid elected actor is chosen by consensus, i.e. when the majority of the network agrees that the elected actors has selected a valid difficulty level falling within the predetermined range. Once a valid actor is finally chosen, the block can be accepted, and the process can continue for future blocks. In some embodiments, if no actor is elected during a block, then the last prime elected actor can emit an empty block with an adjusted difficulty which will trigger a new election. The new election can be confirmed to elect a new prime elected actor, and the process can continue for subsequent blocks as normal.

Although particular advantages and applications of the invention have been explicitly described herein, other advantages and applications may become apparent to a person skilled in the art when reading the present disclosure. The invention is not limited to the embodiments and applications described, and one skilled in the art will understand that numerous modifications can be made without departing from the scope of the invention.

1. A method, comprising:
a) publishing a block on a blockchain network comprising a plurality of actors, said block comprising at least one criterion for selecting an elected actor among the plurality of actors based on a unique election candidacy associated with each one of said actors;
b) receiving election confirmations messages from one or more actors, said election confirmation messages comprising the unique election candidacy associated with each of said one or more actors, and one or more transactions selected by said one or more actors;
c) applying the at least one criterion to validate elected actors among the one or more actors based on the unique election candidacy included in the election confirmation messages; and
d) publishing a subsequent block on the blockchain network, said subsequent block comprising the one or more transactions in the election confirmation messages received from the elected actors.

2. The method according to claim 1, wherein the election confirmation messages are received via a communication on the blockchain network.

3. The method according to claim 1, wherein the election confirmation messages are received via a communication protocol separate from the blockchain network.

4. The method according to claim 3, wherein the election confirmation messages are received by webserver via a Hypertext Transfer Protocol (HTTP) connection.

5. The method according to claim 3, further comprising publishing an election confirmation message on the blockchain network on behalf of the one or more actors, responsive to receiving the election confirmation messages via the webserver.

6. The method according to claim 1, wherein the at least one criterion comprises a difficulty factor defining a probability of any given actor being elected.

7. The method according to claim 1, wherein step c) comprises determining a prime elected actor among the elected actors, and wherein in step d) the subsequent block comprises the one or more transactions specified only by the prime elected actor.

8. The method according to claim 1, wherein step d) comprises merging transactions selected by a plurality of elected actors, and publishing the subsequent block to include the merged transactions.

9. The method according to claim 1, wherein in step b), the election is initiated only once the block published in step a) has matured after a predetermined maturity time.

10. The method according to claim 9, wherein the maturity time is specified in the block published in step a).

11. The method according to claim 9, wherein the maturity time is defined as a block height.

12. The method according to claim 9, wherein step d) is performed only after a manifestation grace period has expired following the initiation of the election.

13. The method according to claim 12, wherein the manifestation grace period is specified in the block published in step a).

14. The method according to claim 12, wherein the manifestation grace period is defined as a block height.

15. The method according to claim 1, wherein step c) further comprises validating an identity of the elected actors and ignoring election confirmation messages from actors which fail validation.

16. The method according to claim 15, wherein validating the identify of the elected actors comprises maintaining an election candidate registry and determining whether the elected actors are in the election candidate registry.

17. The method according to claim 16, wherein maintaining the election candidate registry comprises receiving an encrypted election participation request from a new actor including at least one unique identifier, and decrypting the election participation request and storing the at least one unique identifier in the election candidate registry in association with the new actor.

18. The method according to claim 16, wherein maintaining the election candidate registry comprises receiving an election participation request from a new actor via a communication protocol separate from the blockchain network, said election participation request including at least one unique identifier, and storing the at least one unique identifier in the election candidate registry in association with the new actor.

19. The method according to claim 18, wherein the election participation request is received by a webserver via a HTTP connection.

20. The method according to claim 16, wherein validating the identity of the elected actors comprises attempting to communicate with the elected actors via the at least one unique identifier, the identity being validated if the communication is successful.

21. The method according to claim 20, wherein the at least one unique identifier comprises an IP address of the elected actor.

22. The method according to claim 20, wherein the at least one unique identifier comprises a secret number or code, the identity being validated if the elected actor being validated responds with the secret number or code.

23. The method according to claim 1, wherein steps a) thru d) are carried out by a central trusted node or actor.

24. The method according to claim 1, wherein steps a) thru d) are carried out by one or more public actors.

25. A system, comprising:
a communications module configured to communicate with a plurality of actors on a blockchain network; and
a processing module operatively connected to the communications module, the processing module being configured to:
publish a block on the blockchain network via the communications module, said block comprising at least one criterion for selecting an elected actor among the plurality of actors on the blockchain network based on a unique election candidacy associated with each one of said actors;
receive election confirmations messages from one or more actors via the communications module, said election confirmation messages comprising the unique election candidacy associated with each of said one or more actors, and one or more transactions selected by said one or more actors;
apply the at least one criterion to validate elected actors among the one or more actors based on the unique election candidacy included in the election confirmation messages; and
publish a subsequent block on the blockchain network via the communications module, said subsequent block comprising the one or more transactions in the election confirmation messages received from the elected actors.

26. A non-transitory computer readable medium having instructions stored thereon which, when executed by a processor, cause the processor to perform the steps of:
a) publishing a block on a blockchain network comprising a plurality of actors, said block comprising at least one criterion for selecting an elected actor among the plurality of actors based on a unique election candidacy associated with each one of said actors;
b) receiving election confirmations messages from one or more actors, said election confirmation messages comprising the unique election candidacy associated with each of said one or more actors, and one or more transactions selected by said one or more actors;
c) applying the at least one criterion to validate elected actors among the one or more actors based on the unique election candidacy included in the election confirmation messages; and
d) publishing a subsequent block on the blockchain network, said subsequent block comprising the one or more transactions in the election confirmation messages received from the elected actors.
